(19) United States
(12) Patent Application Publication
(10) Pub. No.: US 2026/0003663 A1
(43) Pub. Date: Jan. 1, 2026

(54) SYSTEMS AND METHODS FOR ANALYZING VIRTUAL MACHINE POOLING

(71) Applicant: Schlumberger Technology Corporation, Sugar Land, TX (US)

(72) Inventors: Jagdish Idhate, Pune (IN); Vijay Kumar, Pune (IN); Akash Bisht, Pune (IN); Ankur Mukherjee, Pune (IN); Kevin Haritmonds, Pune (IN); Vikram Athare, Pune (IN); Divya Nidhi Srivastava, Pune (IN); Mohammad Arief Dharmawan, Jakarta (ID)

(21) Appl. No.: 19/249,077

(22) Filed: Jun. 25, 2025

(30) Foreign Application Priority Data
Jun. 27, 2024 (IN) 202411049457

(51) Int. Cl. G06F 9/455

(52) U.S. Cl. CPC G06F 9/45558; G06F 2009/45595

(57) ABSTRACT

Systems and method presented herein are configured to analyze pooling of virtual machines (VMs) to improve the functionality of such VMs. For example, a VM management platform is configured to maintain a pool of VMs including a plurality of VMs for on-demand access via a plurality of client devices; to access data relating to historical VM usage of VMs provided by the VM management platform; to analyze the data relating to the historical VM usage of the VMs provided by the VM management platform to identify one or more VM recommendations relating to one or more changes to the pool of VMs; and to implement the one or more changes to the pool of VMs based at least in part on the one or more VM recommendations.

### CROSS-REFERENCE TO RELATED APPLICATION

This application claims priority to and the benefit of Indian Application No. 202411049457, entitled “SYSTEMS AND METHODS FOR ANALYZING VIRTUAL MACHINE POOLING,” filed Jun. 27, 2024, which is hereby incorporated by reference in its entirety for all purposes.

### BACKGROUND

The present disclosure generally relates to systems and methods for analyzing pooling of virtual machines (VMs) to improve the functionality of such VMs.

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Virtualization in information systems enables the use of multiple instances of operating systems to run, for example, on a host server. For example, each instance of operating system may utilize a VM having virtual resources such as virtual processors. Such virtualization may be used to implement virtual applications that run within the VMs and that can be accessed via client devices. In order to more efficiently provide access to such VMs, it may be beneficial to analyze usage patterns of users of the VMs.

### SUMMARY

A summary of certain embodiments described herein is set forth below. It should be understood that these aspects are presented merely to provide the reader with a brief summary of these certain embodiments and that these aspects are not intended to limit the scope of this disclosure.

In certain embodiments, a method includes maintaining, via one or more host servers of a virtual machine (VM) management platform, a pool of VMs including a plurality of VMs for on-demand access via a plurality of client devices. The method also includes accessing, via the one or more host servers of the VM management platform, data relating to historical VM usage of VMs provided by the VM management platform. The method further includes analyzing, via the one or more host servers of the VM management platform, the data relating to the historical VM usage of the VMs provided by the VM management platform to identify one or more VM recommendations relating to one or more changes to the pool of VMs. In addition, the method includes implementing, via the one or more host servers of the VM management platform, the one or more changes to the pool of VMs based at least in part on the one or more VM recommendations.

In addition, in certain embodiments, a VM management platform includes one or more host servers, each host server of the one or more host servers including one or more processors configured to execute processor-executable instructions stored in memory of the one or more host servers, wherein the processor-executable instructions, when executed by the one or more processors, cause the one or more host servers to maintain a pool of VMs including a plurality of VMs for on-demand access via a plurality of client devices; to access data relating to historical VM usage of VMs provided by the VM management platform; to analyze the data relating to the historical VM usage of the VMs provided by the VM management platform to identify one or more VM recommendations relating to one or more changes to the pool of VMs; and to implement the one or more changes to the pool of VMs based at least in part on the one or more VM recommendations.

In addition, in certain embodiments, a VM management platform is configured to maintain a pool of VMs including a plurality of VMs for on-demand access via a plurality of client devices; to access data relating to historical VM usage of VMs provided by the VM management platform; to analyze the data relating to the historical VM usage of the VMs provided by the VM management platform to identify one or more VM recommendations relating to one or more changes to the pool of VMs; and to implement the one or more changes to the pool of VMs based at least in part on the one or more VM recommendations.

### BRIEF DESCRIPTION OF THE DRAWINGS

Various aspects of this disclosure may be better understood upon reading the following detailed description and upon reference to the drawings, in which:

FIG. 1 illustrates a virtual machine (VM) management platform configured to maintain a pool of VMs, which may be provided on-demand to client devices to enable users with various industry-specific functionalities, in accordance with an aspect of the present disclosure;

FIG. 2 illustrates an example host server that may be used to create and maintain pools of VMs, in accordance with an aspect of the present disclosure;

FIG. 3 illustrates an example implementation of the VM management platform of FIG. 1, in accordance with an aspect of the present disclosure;

FIG. 4 illustrates a list of types of data that may be used by the VM management platform to determine what VMs to create and maintain as part of VM pools hosted by the VM management platform, in accordance with an aspect of the present disclosure;

FIG. 5 illustrates an example VM usage analysis workflow that may be implemented by the VM management platform, in accordance with an aspect of the present disclosure;

FIG. 6 illustrates a graph of frequency of the top most frequent users to download a TGX file, in accordance with an aspect of the present disclosure;

FIG. 7 illustrated a graph of frequency of the top 50 most frequent users to initiate a VM start, in accordance with an aspect of the present disclosure;

FIG. 8 illustrates a comparison between TGX/RDP file downloads and VM start operations, in accordance with an aspect of the present disclosure;

FIG. 9 illustrates a chart of monthly VM starts by users for different types of VMs, in accordance with an aspect of the present disclosure;

FIG. 10 is an example distribution plot of maximum user engagement per day, in accordance with an aspect of the present disclosure;

FIG. 11 illustrates an example time series decomposition of an underlying time series into a seasonal time series, a trend time series, and a residual time series, in accordance with an aspect of the present disclosure;

FIG. 12 illustrates a graph of example technical indicators of a maximum user engagement time series, in accordance with an aspect of the present disclosure;

FIG. 13 illustrates a graph of an example stationarity test, in accordance with an aspect of the present disclosure;

FIG. 14 illustrates an example Seasonal Auto-Regressive Integrated Moving Averages (SARIMA) model forecast, in accordance with an aspect of the present disclosure;

FIG. 15 illustrates evaluation of the SARIMA model forecast illustrated in FIG. 14, in accordance with an aspect of the present disclosure;

FIG. 16 illustrates forecasts using different machine learning (ML) models and forecasting methods, in accordance with an aspect of the present disclosure;

FIG. 17 shows results of the different ML models and forecasting methods illustrated in FIG. 16, in accordance with an aspect of the present disclosure; and

FIG. 18 is a flow diagram of a method of utilizing the VM management platform to perform analysis of VM usage data for the purpose of optimizing VM pooling, in accordance with an aspect of the present disclosure.

### DETAILED DESCRIPTION

One or more specific embodiments of the present disclosure will be described below. These described embodiments are examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed or caused to be performed, for example, by a computing system (i.e., solely by the computing system, without human intervention). In addition, as used herein, the term “approximately equal to” may be used to mean values that are relatively close to each other (e.g., within 5%, within 2%, within 1%, within 0.5%, or even closer, of each other).

Certain digital platforms provide a plurality of digital solutions for various industry-specific (e.g., petrotechnical) workflows. Such digital solutions may be accessed using profiles covering myriad industry-specific workflows for entire life cycles of the particular industry (e.g., exploration, development, drilling, production, and midstream workflows in E&P life cycles), which are hosted in the cloud and available on demand.

In many situations, such digital platforms utilize virtual machines (VMs) to provide various digital solutions. In conventional digital platforms, when a user logs in via a client device, a VM is created on-demand (e.g., by a host server) and becomes accessible to the user via the client device. In certain scenarios, the process of spinning up a VM for each user may take up to 45 minutes during which the user simply has to wait until the VM is successfully deployed. As such, the creation and configuration of VMs for specific users takes up a considerable amount of time.

The embodiments described herein provide a VM management platform that enables pooling of VMs for the purpose of providing such VMs as efficiently and quickly as possible, while also providing full functionality via the VMs. The VM management platform described herein helps reduce the VM life cycle management automatically via a software-as-a-service (SAAS). With the pooling described herein, a minimum number of VMs may be maintained in a ready state and allocated to users based on specific requests by the users. In this way, wait times experienced by the users will be drastically reduced by the dynamic allocation of the VMs based on the specific requirements of the users.

Furthermore, the embodiments described herein provide a workflow to analyze usage behavior of VMs by users for the purpose of recommending optimum numbers of VMs required for certain sets of users (e.g., that are member of a particular organization). An objective of the workflow is to optimize the VMs available for users, keeping in mind their seamless experience when consuming the VMs and at the same time reducing the cost by making only a necessary numbers of VMs available on a daily basis. Data analytics may be leveraged to examine historical data on VM usage, providing visualizations of daily, weekly, and monthly patterns, as well as finding central tendencies from the datasets. These insights aid in making decisions, such as identifying peak hours of VM utilization for different organizations in different regions, for example. Furthermore, time series forecasting methods may be explored to construct a streamlined workflow that recommends an optimum number of VMs needed in a “hot pool” of VMs, which will be readily available for users and a “cold pool” of VMs, which can be kept in reserve on a daily basis for future dates.

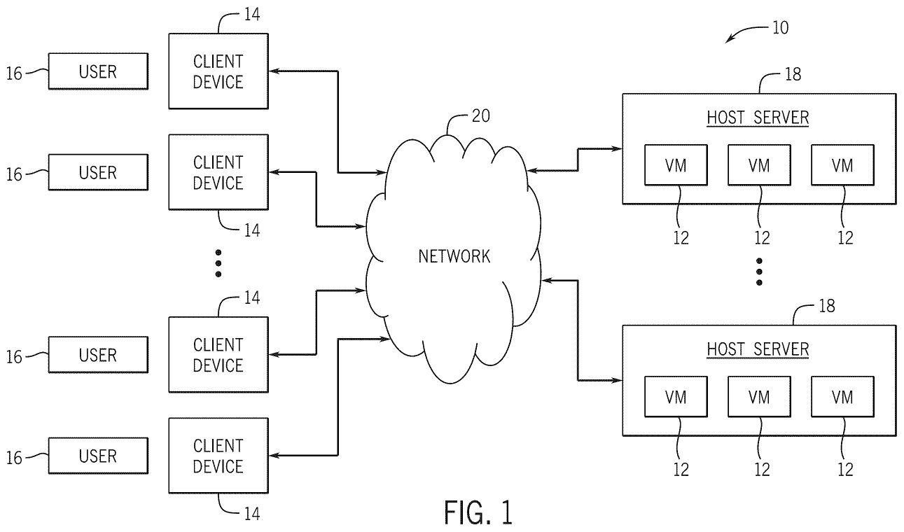

With the foregoing in mind, FIG. 1 illustrates a VM management platform 10 configured to maintain a pool of VMs 12, which may be provided on-demand to client devices 14 to enable users 16 with various industry-specific functionalities. As illustrated in FIG. 1, the VM management platform 10 may include host servers 18, each host server 18 configured to provide a plurality of VMs 12 to a plurality of client devices 14 via a network 20 on-demand in response to requests by associated users 16. In particular, as described in greater detail herein, the host servers 18 may be configured to provide VMs 12 from a pool of VMs 12 hosted by the host servers 18 to the client devices 14 to enable faster and more reliable access to the VMs 12 such that the client devices 14 can use the various industry-specific functionalities more readily.

In addition, as described in greater detail herein, the host servers 18 may be configured to maintain particular VMs 12 in the pool of VMs 12 based on various characteristics of the users 16 using the client devices 14 including, but not limited to, specific organizations (e.g., companies, operating entities, and so forth) of which the users 16 are members (e.g., as employees, operators, and so forth), specific roles (e.g., management, engineering, and so forth) performed by the users 16 for their associated organizations, projects that the users 16 are assigned to for their associated organizations, usage histories for the users 16 of various industry-specific functionalities provided by the VMs 12, geographical areas or locations of the users 16 and/or the client devices 14 used by the users 16, and so forth.

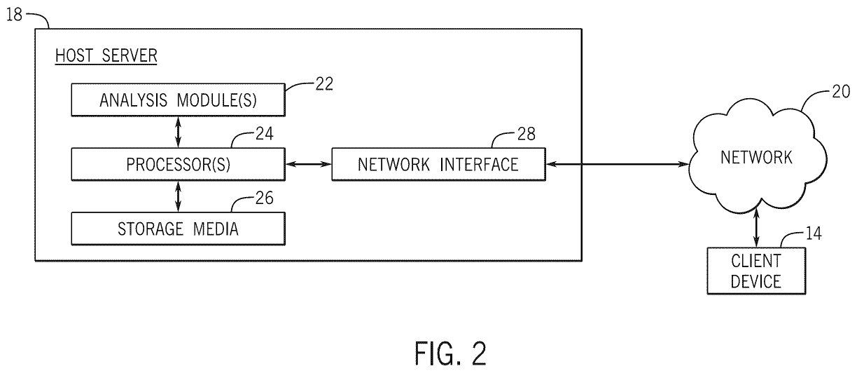

FIG. 2 illustrates an example host server 18 that may be used to create and maintain pools of VMs 12, as described in greater detail herein. In certain embodiments, the host server 18 may include one or more analysis modules 22 (e.g., a program of computer-executable instructions and associated data) that may be configured to perform various functions of the embodiments described herein. For example, the analysis modules 22 of the host servers 18 described herein may be configured to determine how to maintain and configure pools of VMs 12 based on data received relating to on-demand requests for VMs 12 received from client devices 14, as described in greater detail herein. Furthermore, as described in greater detail herein, the analysis modules 22 of the host servers 18 may also be configured to analyze usage behavior of VMs 12 by users 16 for the purpose of recommending optimum numbers of VMs 12 required for certain sets of users 16.

In certain embodiments, to perform these various functions, the one or more analysis modules 22 may execute on one or more processors 24 of the host server 18, which may be connected to one or more storage media 26 of the host server 18. Indeed, in certain embodiments, the one or more analysis modules 22 may be stored in the one or more storage media 26. In certain embodiments, the computer-executable instructions of the one or more analysis modules 22, when executed by the one or more processors 24, may cause the one or more processors 24 to perform the VM pooling and analysis techniques described in greater detail herein. In certain embodiments, the analysis modules 22 that enable the embodiments described herein may run locally (e.g., on a local computer), as a cloud-based solution, or as a plugin to existing software.

In certain embodiments, the one or more processors 24 may include a microprocessor, a microcontroller, a processor module or subsystem, a programmable integrated circuit, a programmable gate array, a digital signal processor (DSP), or another control or computing device. In certain embodiments, the one or more processors 24 may include machine learning (ML) and/or artificial intelligence (AI) based processors that, for example, enable the one or more processors 24 to determine how to maintain pools of VMs 12, as described in greater detail herein. For example, as described in greater detail herein, the ML and/or AI based processors may be configured to analyze VM usage of various users to determine how to maintain the pool of VMs 12 such that, for example, access to the VMs 12 is much faster than with conventional techniques.

In certain embodiments, the one or more storage media 26 may be implemented as one or more non-transitory computer-readable or machine-readable storage media. In certain embodiments, the one or more storage media 26 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. It should be noted that the computer-executable instructions and associated data of the analysis module(s) 22 may be provided on one computer-readable or machine-readable storage medium of the storage media 26, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 26 may be located either in the machine running the machine-readable instructions, or may be located at a remote site from which machine-readable instructions may be downloaded over a network for execution. In addition, in certain embodiments, the processor(s) 24 may be connected to a network interface 28 of the host server 18 to allow the host server 18 to, for example, communicate with various client devices 14 via a network 20 for the purpose of providing VMs 12 to the client devices 14 on-demand, as described in greater detail herein.

It should be appreciated that the VM management platform 10 illustrated in FIG. 2 is only one example of a VM management platform, and that the VM management platform 10 may have more or fewer components than shown, may combine additional components not depicted in the embodiment of FIG. 2, and/or the VM management platform 10 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the VM management platform 10 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

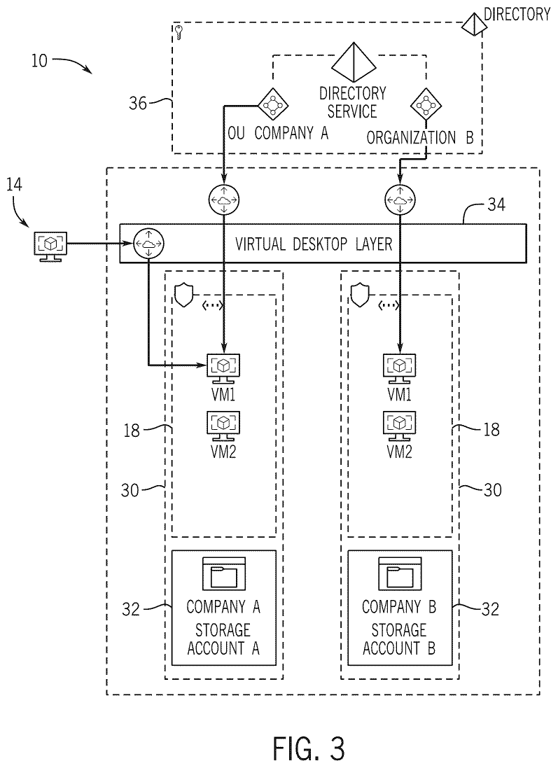

FIG. 3 illustrates an example implementation of the VM management platform 10 of FIG. 1. As illustrated, in certain embodiments, the VM management platform 10 may include a plurality of host servers 18 that are configured to create and maintain pools of VMs 12 for provision to a plurality of client devices 14, as described in greater detail herein. The embodiment illustrated in FIG. 3 includes two resource groups 30, each resource group 30 including a host server 18 and one or more file storage sources 32, within which data used by the various VMs 12 are stored. However, it will be appreciated that the VM management platform 10 may include any number of resource groups 30 for creating and maintaining pools of VMs 12, as described in greater detail herein. As also illustrated in FIG. 3, in certain embodiments, the file storage sources 32 may be organization-specific (e.g., specific to certain companies). However, in other embodiments, the file storage sources 32 may be role-specific (e.g., management, engineering, and so forth) performed by users 16 for their associated organizations, project-specific, historical usage-specific, geographic area-specific or location-specific, and so forth.

As also illustrated in FIG. 3, the VM management platform 10 may include a virtual desktop layer 34 that functions as a routing mechanism for receiving VM requests from client devices 14 for VMs 12, determining which host server 18 to route the VM requests to, and then communicating to the client devices 14 which host server 18 they should be connecting to enable the respective VM 12 to be used by the client devices 14. It will be appreciated that, in certain embodiments, the virtual desktop layer 34 may be enabled by one or more host servers 18 that are simply performing different functions of the VM management platform 10 than the host servers 18 hosting the VMs 12. In other words, such host servers 18 may include processing and analysis components substantially similar to the host servers 18 illustrated in FIG. 2. However, their respective analysis modules 22 may simply perform different functions of the VM management platform 10 than the host servers 18 hosting the VMs 12. For example, in certain embodiments, the host servers 18 in the virtual desktop layer 34 may be configured to analyze historical VM usage by users 16 such that the host servers 18 in the virtual desktop layer 34 may determine how best to maintain the pools of VM 12 provided by the host servers 18 hosting the VMs 12.

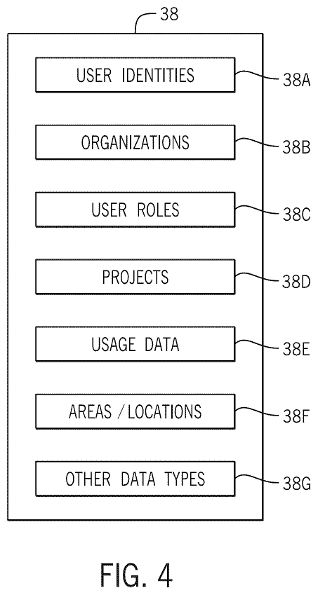

As also illustrated in FIG. 3, in certain embodiments, the virtual desktop layer 34 may work with both managed directory services (e.g., Active Directory Domain Services developed by Microsoft for Windows domains specific to certain organizations) as well as local directory services for identity management of the various users 16 utilizing the VM management platform 10 via client devices 14 as a shared subscription layer 36. In addition, the directory services may be configured to store user profiles for users 16 that include data types (e.g., the data types described with reference to FIG. 4) that may be used by the virtual desktop layer 34 to determine certain characteristics of users 16 requesting access to VMs 12, which may be used by the virtual desktop layer 34 to identify pooled VMs 12 to which the users 16 should be given access.

Furthermore, in certain embodiments, the virtual desktop layer 34 may be capable of syncing local directory services with managed directory services to make the resources available as a cloud service enabled by the VM management platform 10. As such, in general, the virtual desktop layer 34 handles web access, provides gateway, broker, and diagnostics services, and employs extensibility components such as application programming interfaces (APIs) that enable the client devices 14, host servers 18, and other computing systems to access the various functionality of the VM management platform 10, which are described in greater detail herein. For example, once the virtual desktop layer 34 identifies a particular VM 12 to provide access to for a particular client device 14, the virtual desktop layer 34 may send a command signal to the client device 14 to automatically launch a virtual desktop application to alert a user 16 of the client device 14 that the VM 12 is now ready for use via the client device 14.

In addition, in certain embodiments, the virtual desktop layer 34 may release patched images via host session mechanisms, which enable VMs 12 used by the client devices 14 to be patched via a SAAS provided by the VM management platform 10. In general, the virtual desktop layer 34 enables the VM management platform 10 to manage the various VM resources described herein for users 16 and their associated organizations. Doing so reduces the costs of development support since the service provided by the VM management platform 10 is a SAAS. In addition, the virtual desktop layer 34 may be configured to enable profile saving of profiles of the users 16 accessing the VM management platform 10, as described in greater detail herein.

As described in greater detail herein, the VM management platform 10 is configured to create and maintain pools of VMs 12 that enable the VM management platform 10 to provide VMs to users 16 on-demand in a relatively fast and efficient manner. For example, in certain embodiments, based on data relating to historical usage of VMs 12 via the VM management platform 10, the VM management platform 10 may know the types of functionalities of VMs 12 that tend to be requested at particular times, from particular geographical areas and locations, and so forth, and may use this knowledge to determine what types of VMs 12 to create and maintain in pools of VMs 12 via specific host servers 18 such that appropriate VMs 12 may be provided to client devices 14 used by specific users 16 in a relatively fast and efficient manner upon request from the client devices 14.

In certain embodiments, the VM management platform 10 may be configured to create and maintain the pools of VMs 12 that are available for client devices 14 to access based on various types of data relating to users 16 (e.g., that are at least partially stored within the directory services of the shared subscription layer 36 as user profile data) utilizing the VM management platform 10.

For example, FIG. 4 illustrates a non-limiting list of the types 38 of data that may be used by the VM management platform 10 to determine what VMs 12 to create and maintain as part of the VM pools hosted by the VM management platform 10. In certain embodiments, the data types 38 may include user identities 38A of users 16 accessing VM functionalities provided by the VM management platform 10. In addition, in certain embodiments, the data types 38 may include specific organizations 38B (e.g., companies, operating entities, and so forth) of which the users 16 are members (e.g., as employees, operators, and so forth). In addition, in certain embodiments, the data types 38 may include specific user roles 38C (e.g., management, engineering, and so forth) performed by the users 16 for their associated organizations. In addition, in certain embodiments, the data types 38 may include projects 38D that the users 16 are assigned to for their associated organizations. In addition, in certain embodiments, the data types 38 may include historical usage data 38E for the users 16 of various industry-specific functionalities provided by the VMs 12. In addition, in certain embodiments, the data types 38 may include geographical areas or locations 38F of the users 16 and/or the client devices 14 used by the users 16. It will be appreciated that the types 38 of data illustrated in FIG. 4 are merely exemplary and are not intended to be limiting. Indeed, other types 38G of data may be used by the VM management platform 10 to determine what VMs 12 to create and maintain as a pool of VMs 12 such that the VMs 12 may be utilized by users 16 of the VM management platform 10 on-demand upon request from the users 16.

It will be appreciated that, in certain embodiments, the data formats of the user profile data types 38 illustrated in FIG. 4 may be different than the data formats for data stored in the various file storage sources 32 of the VM management platform 10. For example, data relating to the user profile data types 38 may be organization-specific whereas data stored in the file storage sources 32 may be industry-specific. As such, the two different types of data may include data that is intended to relate to identical data types, but the data formatting of the different types of data may be somewhat incompatible. As such, in certain embodiments, the host servers 18 of the VM management platform 10 described herein may be configured to perform automatic data conversion between such different data formats such that the differences between the data formats are not even noticed by users 16 of the VM management platform 10. Indeed, as described above, in certain embodiments, the host servers 18 of the VM management platform 10 may include ML and/or artificial intelligence (AI) based algorithms that are configured to be trained on such different types of data formats to automatically learn over time how to more accurately and efficiently convert between the different types of data formats.

As discussed above, the embodiments described herein provide a workflow to analyze usage behavior of VMs 12 by users 16 for the purpose of recommending optimum numbers of VMs 12 required for certain sets of users 16 (e.g., that are member of a particular organization). In particular, the VM management platform 10 may be configured to employ datasets centered around the analysis of historical VM usage data in the context of the VM pooling provided by the VM management platform 10, as described in greater detail herein. In general, user-generated data concerning VM operations, specifically focusing on VM start and VM creation events, may be analyzed. Furthermore, the analysis may also be based on user downloads (e.g., of TGX and RDP files) to enable even further insight regarding usage of users 16 of the VM management platform 10 described herein. In addition, the analysis may also be based on categorizations of different VM sizes to further enable insight into an amount of load the users 16 are putting on specific types of VMs 12.

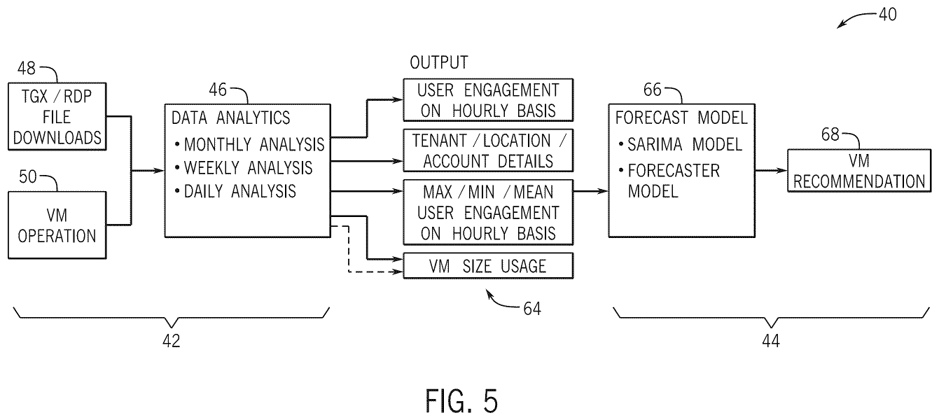

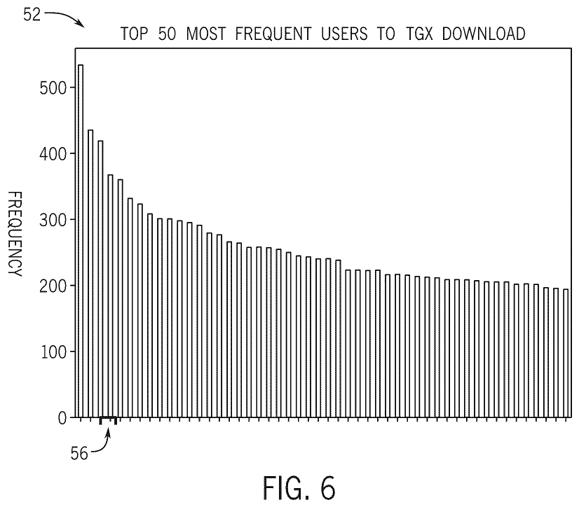

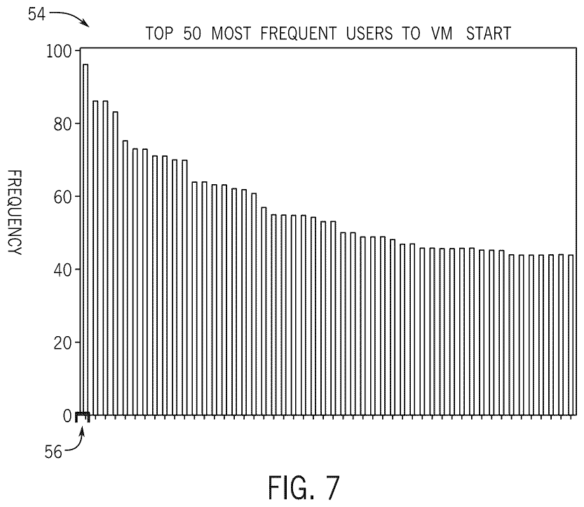

FIG. 5 illustrates an example VM usage analysis workflow that may be implemented by the VM management platform 10, as described in greater detail herein. As illustrated, the workflow 40 is developed in two phases 42, 44. In a first phase 42, data analytics 46 may be used by the VM management platform 10 to analyze user patterns from available historical data. For example, as but one non-limiting example, patterns of TGX or RDP file downloads 48 and VM operations data 50 (e.g., VM starts) by users 16 may be compared (e.g., on a monthly, weekly, or daily basis) using the data analytics 46. The pattern of most frequent users 16 and number of unique users 16 (e.g., associated with specific organizations) may be analyzed. For example, FIG. 6 illustrates a graph 52 of frequency of the top 50 most frequent users 16 to download a TGX file, and FIG. 7 illustrated a graph 54 of frequency of the top 50 most frequent users to initiate a VM start. It will be appreciated that each of these data points relates to a unique user 16, such as the data points for a first unique user, denoted by arrows 56.

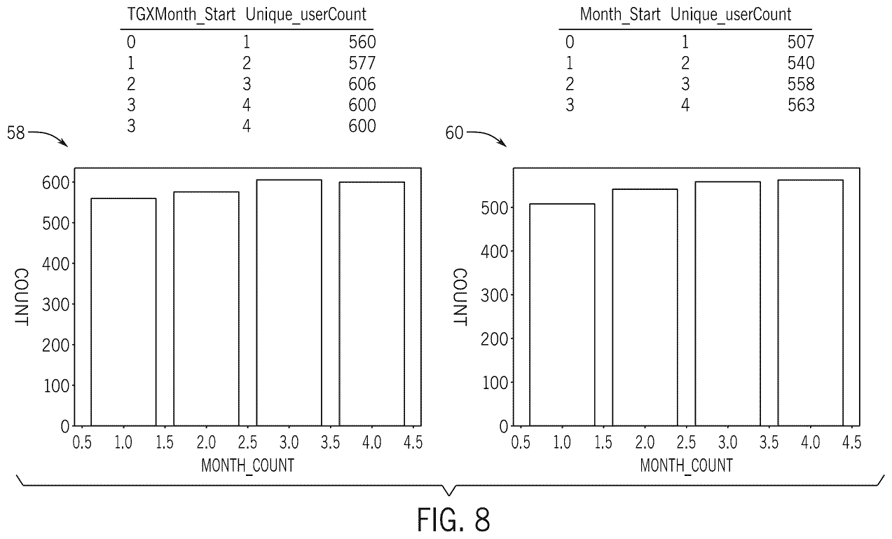

FIG. 8 illustrates a comparison between TGX/RDP file downloads 48 (e.g., as illustrated by chart 58) and VM start operations 50 (e.g., as illustrated by chart 60). It has been found that the data relating to TGX/RDP file downloads 48 alone are not a relatively strong indicator of usage of VMs 12, as it has been observed that there is no fixed behavior of users 16 after downloading the TGX/RDP files. For example, there are many instances of multiple downloads by users 16, but where the users 16 do not start a VM 12 right after downloading. Therefore, the analysis of TGX/RDP file downloads 48 nay be limited to validation of VM start operations 50 only.

From the analysis of VM start operations 50, it is recognized that there is a “duplication” behavior in the usage. Multiple clicks by users 16 during VM starts 50 might be the cause of such “duplication”. As such, in certain embodiments, multiple occurrences of VM start data for a particular user 16 may be removed from a defined time interval (e.g., a 1-hour time interval). Then, patterns of VM starts may be analyzed on a monthly, weekly, and hourly basis to check what time of day experiences the maximum engagement by users 16. Such analysis enables the VM management platform 10 to estimate VM start and stop times, should there be such requirements from the users 16. Then, central tendencies (e.g., maximum user engagement, mean engagements per hour, and so forth) may be calculated. In addition, the anonymity of VM start operations 50 may be checked on certain days.

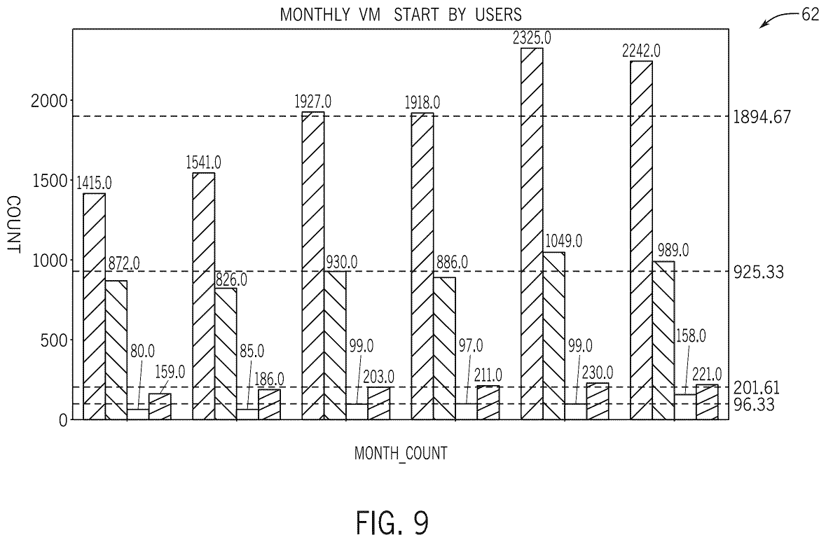

Next, the analysis may be segregated based on different VM sizes, taking into consideration all VM sizes used by the users 16 for a particular organization. Analysis of usage of this data paved a path to prepare the input data that could then be used for the time series analysis (TSA) described in greater detail below. FIG. 9 illustrates a chart 62 of monthly VM starts by users 16 for different types of VMs 12. Returning to the workflow 40 of FIG. 5, the structured output dataset 64 of the data analytics of the first phase 42 is another set of useful data containing, for example, total daily user engagements per hour at 1-hour intervals, maximum users 16 arriving per day, average users 16 per day along with their associated organization (e.g., tenant), location and country information, and so forth.

The second phase 44 of the workflow 40 is a TSA on a concise and structured output dataset 64 obtained from the first phase 42 of the workflow 40 using a forecast model 66 to generate VM recommendations 68. In order to generate recommendations of VM pool size, for example, it is relatively important to know the maximum user engagements per day for a particular organization so that the maximum users 16 may be catered with a seamless experience of using the VMs 12.

The TSA performed by the forecast model 66 involves analysis and prediction of temporal series through various approaches, which may broadly be categorized into either a statistical approach or a soft-computing approach. Temporal series may be described as a compilation of observations in a sequential way over a specific time period (preferably on a regular interval). One non-limiting example goal of the TSA is to build a precise and reliable forecast for maximum user engagement for different VM sizes. The TSA process workflow may be divided into the following major phases: (1) data exploration, preprocessing, and feature engineering; (2) transforming raw data to stationary data; and (3) applying various time series models.

### Data Exploration, Preprocessing, and Feature Engineering

Data exploration, preprocessing, and feature engineering may be performed with primary objectives to understand various aspects of the temporal series, to select relevant input variables, and to generate additional variables for a time series ML model. An example preprocessing scenario consists of descriptive statistics, time series decomposition, and feature engineering.

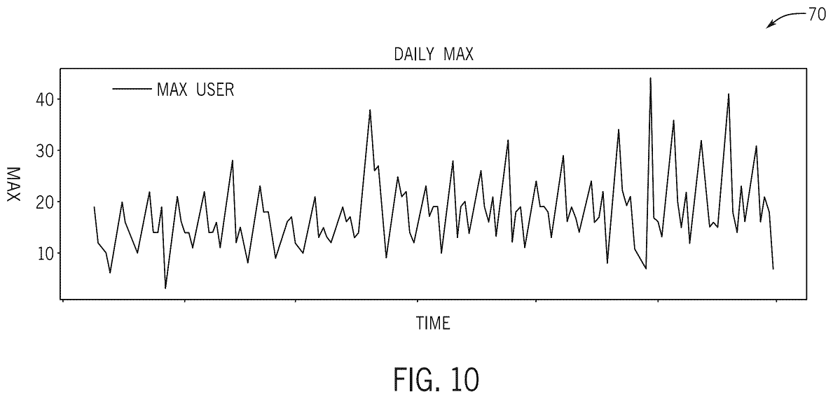

Descriptive statistics may, for example, include distribution plots (e.g., visualizations of distribution), statistical parameters (e.g., rolling mean, rolling standard deviation, and so forth), among others. FIG. 10 is an example distribution plot 70 of maximum user engagement (e.g., VM starts) per day, as but one example of descriptive statistics.

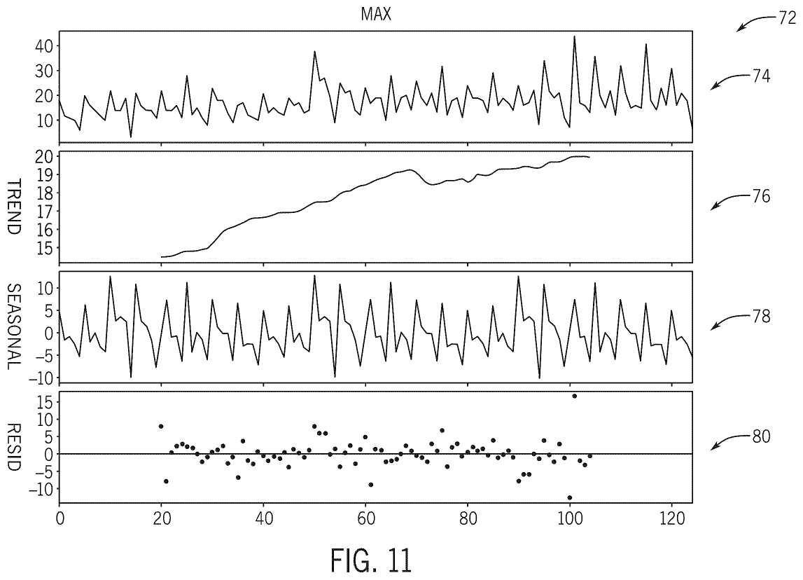

Time series decomposition generally involves transforming a time series into multiple different time series. Such time series decomposition may, for example, include decomposition of underlying time series into seasonal time series (e.g., patterns that repeat with a fixed period of time), trend time series (e.g., underlying trends of the metrics), and random/error time series (e.g., residuals after the seasonal and trend series are removed). FIG. 11 illustrates an example time series decomposition 72 of an underlying time series 74 into a seasonal time series 76, a trend time series 78, and a residual time series 80.

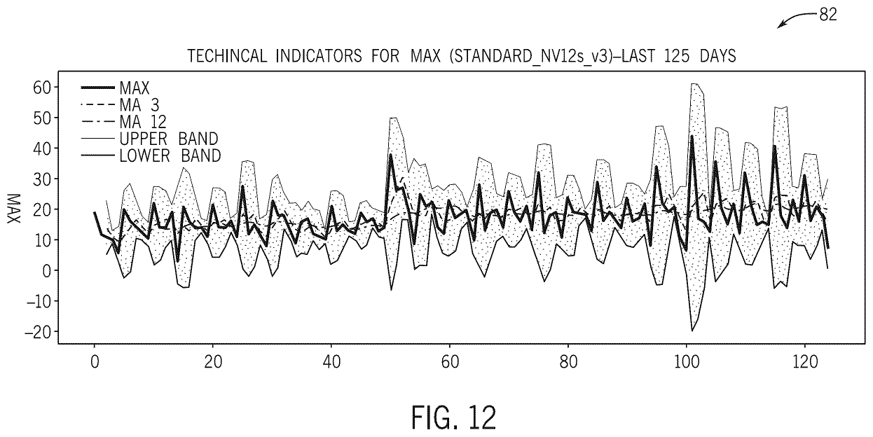

Feature engineering may be used to generate additional features of the time series including, for example, moving averages (MA) (e.g., simple moving averages of for 3-month periods and 12-month periods of a target variable), exponential moving average (EMA) (e.g., moving averages with more weight to recent time lags, for example), moving average convergence/divergence (MACD) (e.g., difference between two moving averages of different lengths), Bollinger bands (e.g., prevailing upper and lower bound limits of a time series), momentum (e.g., measurement of the speed or velocity of target variable changes, for example, rate of change in gas rate for a particular well), standard deviations (e.g., 6-month standard deviations), and so forth. FIG. 12 illustrates a graph 82 of example technical indicators of a maximum user engagement time series.

### Transform Raw Data to Stationary Data

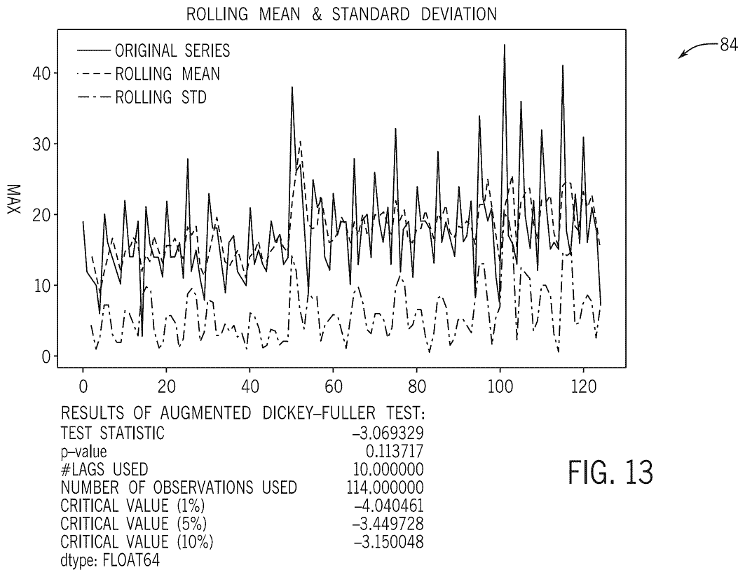

A temporal series is said to be stationary if its properties do not depend upon the time at which the time series is observed (e.g., no seasonality; no trends; mean, variance and autocorrelation structure remain constant over time, and so forth). Most of the time series models work on the assumption that the series is stationary. However, stationarity of a time series may be checked by using: (1) ACF (Autocorrelation Function) and PACF (Partial Autocorrelation Function) plots, (2) plotting rolling statistics, and (3) Augmented Dickey-Fuller Test (Unit Root test). FIG. 13 illustrates a graph 84 of an example stationarity test.

### Applying Various Time Series Models

After performing data pre-processing, generating new features, and transforming time series into a stationary series, time series models for forecasting user engagement may be deployed. Two methods were tested for forecasting, namely, (1) Seasonal Auto-Regressive Integrated Moving Averages (SARIMA), and (2) using Scalecast Forecaster library for future predictions using ML methods such K-nearest neighbor (KNN), support vector machine regression (SVR), random forest (RF), and so forth.

### SARIMA

SARIMA is an extension of ARIMA that explicitly supports univariate time series data with a seasonal component. It adds three new hyperparameters to specify the autoregression (AR), differencing (I) and moving average (MA) for the seasonal component of the times series, as well as an additional parameter for the period of the seasonality. The hyperparameters of SARIMA method are:
p: Trend autoregression order
d: Trend difference order
q: Trend moving average order
P: Seasonal autoregressive order
D: Seasonal difference order
Q: Seasonal moving average order
m: The number of time steps for a single seasonal period

$${y}_{t} = c + {\sum }_{n = 1}^{p} {a}_{n} {y}_{t - n} + {\sum }_{n = 1}^{q} {θ}_{n} {e}_{t - n} + {\sum }_{n = 1}^{P} {ϕ}_{n} {y}_{t - m} + {\sum }_{n = 1}^{Q} {η}_{n} {e}_{t - m} + {e}_{t}$$

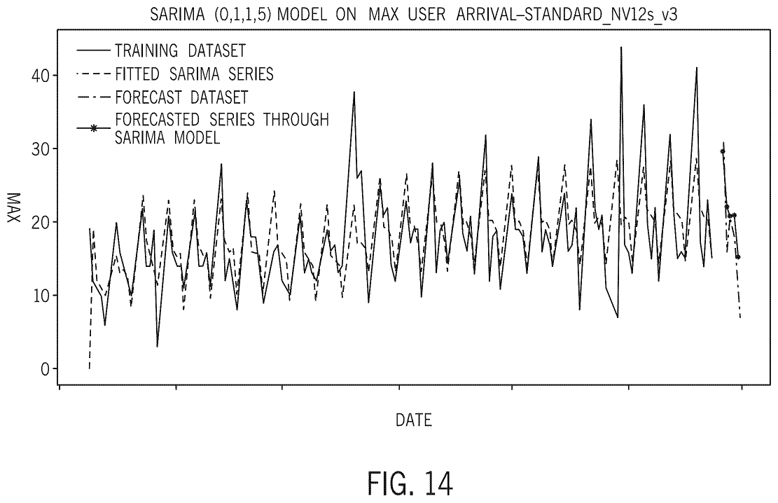

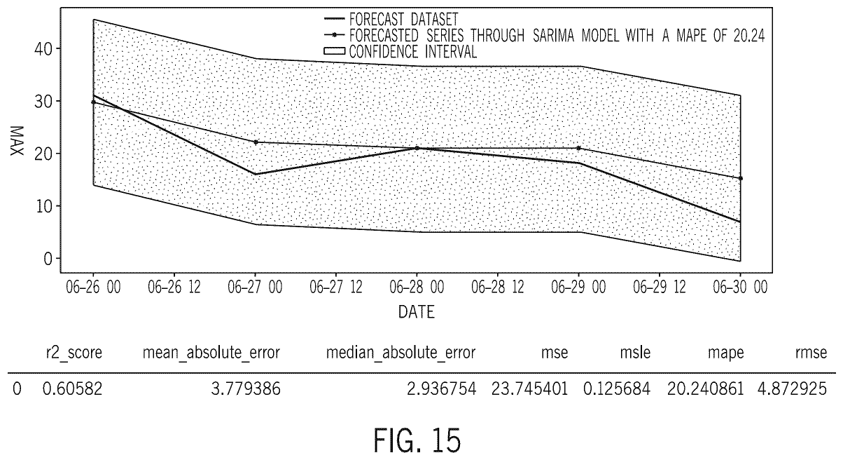

FIG. 14 illustrates an example SARIMA model forecast, and FIG. 15 illustrates evaluation of the SARIMA model forecast illustrated in FIG. 14. To find the best parameters of the SARIMA model, a trial and error method was used to obtain the best R2 score for forecast prediction. A confidence interval of the fitted data obtained from the model was also computed.

### ML Algorithm

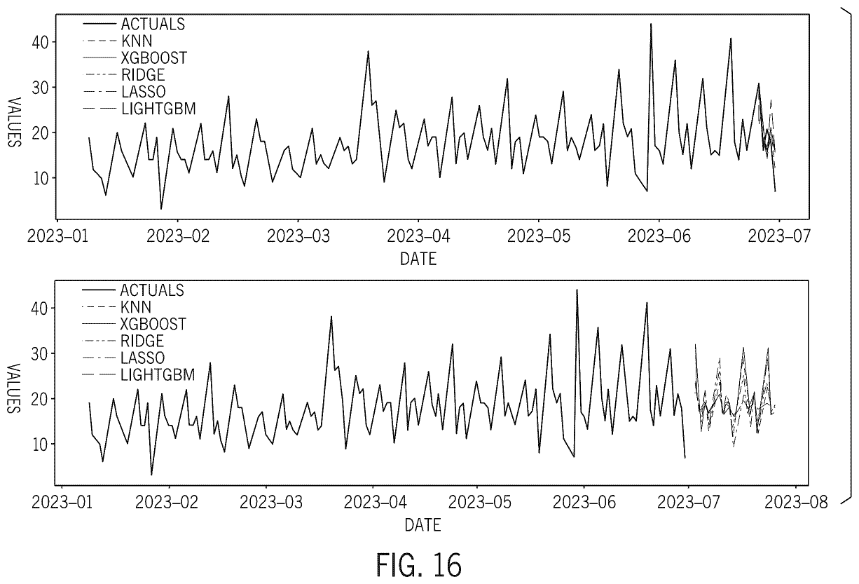

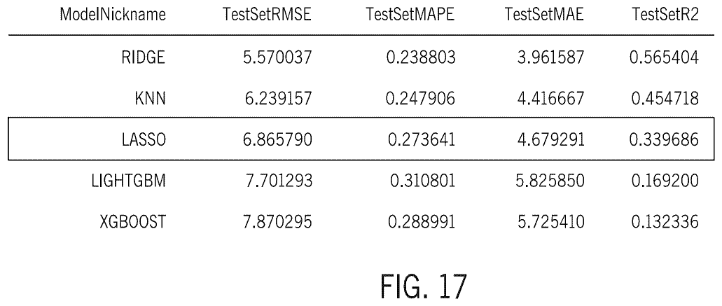

Scalecast's Forecaster library, which uses minimal code to examine time series and forecast with popular and well-known machine learning models, was used for the ML model. KNN, xgboost, Light GBM, lasso, and ridge methods were used for forecasting. However, many other types of ML models and forecasting methods may also be used. FIG. 16 illustrates forecasts using different ML models and forecasting methods, and FIG. 17 shows results of the different ML models and forecasting methods illustrated in FIG. 16. Ultimately, SARIMA models were chosen as the mean absolute percent error (MAPE) and R2 metrics were better for the model.

As discussed above, the VM usage analysis enabled by the workflow presented in FIG. 5 and described in further detail with reference to FIGS. 6-17 may be based on myriad VM usage variables including, but not limited to core VM usage data such as TGX/RDP file downloads 48 and VM start operations 50, as well as more user-specific and organization-specific data such as data types 38 discussed above with reference to FIG. 4. As but one non-limiting example, data relating to VM usage for particular geographical areas and locations 38F may provide insights into what host servers 18, from a geographical perspective, should maintain VM pools that will be capable of providing access to VMs 12 on-demand more quickly and efficiently to users 16 located in those particular geographical areas and locations 38F. Indeed, any combination of the types of VM usage data presented herein may be used together to enable the VM management platform 10 to maintain appropriate VM pools, as described in greater detail herein.

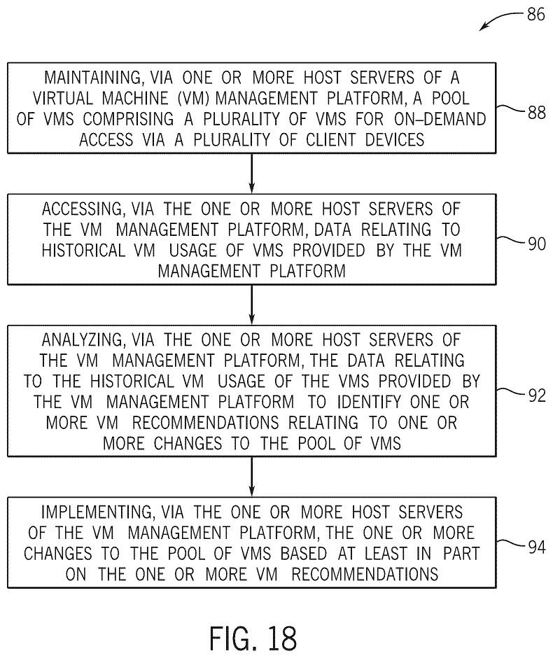

FIG. 18 is a flow diagram of a method 86 of utilizing the VM management platform 10 to perform analysis of VM usage data for the purpose of optimizing VM pooling, as described in greater detail herein. As illustrated in FIG. 18, the method 86 may include maintaining, via one or more host servers 18 of a VM management platform 10, a pool of VMs 12 for on-demand access via a plurality of client devices 14 (block 88). In addition, the method 86 may include accessing, via the one or more host servers 18 of the VM management platform 10, data relating to historical VM usage of VMs 12 provided by the VM management platform 10 (block 90). In addition, the method 86 may include analyzing, via the one or more host servers 18 of the VM management platform 10, the data relating to the historical VM usage of the VMs 12 provided by the VM management platform 10 to identify one or more VM recommendations relating to one or more changes to the pool of VMs 12 (block 92). In addition, the method 86 may include implementing, via the one or more host servers 18 of the VM management platform 10, the one or more changes to the pool of VMs 12 based at least in part on the one or more VM recommendations (block 94).

In certain embodiments, analyzing, via the one or more host servers 18 of the VM management platform 10, the data relating to the historical VM usage includes performing data analytics on the data relating to the historical VM usage. In addition, in certain embodiments, analyzing, via the one or more host servers 18 of the VM management platform 10, the data relating to the historical VM usage includes performing data exploration, preprocessing, and feature engineering on one or more time series included in the data relating to the historical VM usage. In certain embodiments, the data exploration, preprocessing, and feature engineering includes generating descriptive statistics for the one or more time series. In addition, in certain embodiments, the data exploration, preprocessing, and feature engineering includes performing time series decomposition of the one or more time series. In certain embodiments, the time series decomposition includes decomposing each time series of the one or more time series into a seasonal time series, a trend time series, and a random/error time series. In addition, in certain embodiments, the data exploration, preprocessing, and feature engineering includes generating additional features of the one or more time series. In addition, in certain embodiments, analyzing, via the one or more host servers 18 of the VM management platform 10, the data relating to the historical VM usage includes determining the stationarity of each time series of the one or more time series. In addition, in certain embodiments, analyzing, via the one or more host servers 18 of the VM management platform 10, the data relating to the historical VM usage includes applying a time series model to the one or more time series.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A method, comprising:
maintaining, via one or more host servers of a virtual machine (VM) management platform, a pool of VMs comprising a plurality of VMs for on-demand access via a plurality of client devices;
accessing, via the one or more host servers of the VM management platform, data relating to historical VM usage of VMs provided by the VM management platform;
analyzing, via the one or more host servers of the VM management platform, the data relating to the historical VM usage of the VMs provided by the VM management platform to identify one or more VM recommendations relating to one or more changes to the pool of VMs; and
implementing, via the one or more host servers of the VM management platform, the one or more changes to the pool of VMs based at least in part on the one or more VM recommendations.

2. The method of claim 1, wherein analyzing, via the one or more host servers of the VM management platform, the data relating to the historical VM usage comprises performing data analytics on the data relating to the historical VM usage.

3. The method of claim 1, wherein analyzing, via the one or more host servers of the VM management platform, the data relating to the historical VM usage comprises performing data exploration, preprocessing, and feature engineering on one or more time series included in the data relating to the historical VM usage.

4. The method of claim 3, wherein the data exploration, preprocessing, and feature engineering comprises generating descriptive statistics for the one or more time series.

5. The method of claim 3, wherein the data exploration, preprocessing, and feature engineering comprises performing time series decomposition of the one or more time series.

6. The method of claim 5, wherein the time series decomposition comprises decomposing each time series of the one or more time series into a seasonal time series, a trend time series, and a random/error time series.

7. The method of claim 3, wherein the data exploration, preprocessing, and feature engineering comprises generating additional features of the one or more time series.

8. The method of claim 3, wherein analyzing, via the one or more host servers of the VM management platform, the data relating to the historical VM usage comprises determining a stationarity of each time series of the one or more time series.

9. The method of claim 8, wherein analyzing, via the one or more host servers of the VM management platform, the data relating to the historical VM usage comprises applying a time series model to the one or more time series.

10. A virtual machine (VM) management platform, comprising:
one or more host servers, each host server of the one or more host servers comprising one or more processors configured to execute processor-executable instructions stored in memory of the one or more host servers, wherein the processor-executable instructions, when executed by the one or more processors, cause the one or more host servers to:
maintain a pool of VMs comprising a plurality of VMs for on-demand access via a plurality of client devices;
access data relating to historical VM usage of VMs provided by the VM management platform;
analyze the data relating to the historical VM usage of the VMs provided by the VM management platform to identify one or more VM recommendations relating to one or more changes to the pool of VMs; and
implement the one or more changes to the pool of VMs based at least in part on the one or more VM recommendations.

11. The VM management platform of claim 10, wherein analyzing the data relating to the historical VM usage comprises performing data analytics on the data relating to the historical VM usage.

12. The VM management platform of claim 10, wherein analyzing the data relating to the historical VM usage comprises performing data exploration, preprocessing, and feature engineering on one or more time series included in the data relating to the historical VM usage.

13. The VM management platform of claim 12, wherein the data exploration,
preprocessing, and feature engineering comprises generating descriptive statistics for the one or more time series.

14. The VM management platform of claim 12, wherein the data exploration,
preprocessing, and feature engineering comprises performing time series decomposition of the one or more time series.

15. The VM management platform of claim 14, wherein the time series decomposition comprises decomposing each time series of the one or more time series into a seasonal time series, a trend time series, and a random/error time series.

16. The VM management platform of claim 12, wherein the data exploration,
preprocessing, and feature engineering comprises generating additional features of the one or more time series.

17. The VM management platform of claim 12, wherein analyzing the data relating to the historical VM usage comprises determining a stationarity of each time series of the one or more time series.

18. The VM management platform of claim 17, wherein analyzing the data relating to the historical VM usage comprises applying a time series model to the one or more time series.

19. A virtual machine (VM) management platform configured to:
maintain a pool of VMs comprising a plurality of VMs for on-demand access via a plurality of client devices;
access data relating to historical VM usage of VMs provided by the VM management platform;
analyze the data relating to the historical VM usage of the VMs provided by the VM management platform to identify one or more VM recommendations relating to one or more changes to the pool of VMs; and
implement the one or more changes to the pool of VMs based at least in part on the one or more VM recommendations.

20. The VM management platform of claim 19, wherein analyzing the data relating to the historical VM usage comprises performing data analytics on the data relating to the historical VM usage.
